(19) United States
(12) Patent Application Publication
(10) Pub. No.: US 2016/0131866 A1
(43) Pub. Date: May 12, 2016

(54) LENS DRIVING MODULE

(71) Applicant: SAMSUNG ELECTRO-MECHANICS CO., LTD., Suwon-si (KR)

(72) Inventors: Dae Ho KIM, Suwon-si (KR); Sang Jin KIM, Suwon-si (KR); Jong Beom KIM, Suwon-si (KR)

(73) Assignee: SAMSUNG ELECTRO-MECHANICS CO., LTD., Suwon-si (KR)

(21) Appl. No.: 14/881,585

(22) Filed: Oct. 13, 2015

(30) Foreign Application Priority Data
Nov. 7, 2014 (KR) 10-2014-0154721

(51) Int. Cl. G02B 7/08

(52) U.S. Cl. CPC G02B 7/08

(57) ABSTRACT

A lens driving module includes a first actuator and a second actuator. The first actuator is configured to move a lens unit. The second actuator is configured to move the lens unit. The first and second actuators are connected to be movable relative to each other.

### CROSS-REFERENCE TO RELATED APPLICATION(S)

This application claims the benefit under 35 USC 119(a) of Korean Patent Application No. 10-2014-0154721 filed on Nov. 7, 2014, with the Korean Intellectual Property Office, the disclosure of which is incorporated herein by reference.

### BACKGROUND

1. Field

The following description relates to a lens driving module to adjust focus.

2. Description of Related Art

A high resolution camera device includes a plurality of lenses and an image sensor. This camera device also includes a moving structural element, which moves a lens barrel in an optical axis direction in order to obtain or realize a clear image.

However, because the moving structural element moves the lens barrel, which has significant mass, to adjust a focal length, a considerable amount of current is consumed. Also, the moving structural element has a complex structure, which is disadvantageous in regard to the miniaturization of the camera device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a lens driving module, including: a first actuator configured to move a lens unit; and a second actuator configured to move the lens unit, wherein the first and second actuators are connected to be movable relative to each other.

The lens driving module may also include a third actuator connected to at least one of the first and second actuators.

The first and second actuators may be disposed in a direction perpendicular to an optical axis of the lens unit.

The first and second actuators may be disposed to be symmetrical to each other with respect to the lens unit.

The first and second actuators may be parallel to each other.

The first and second actuators may have different lengths.

The first and second actuators may provide different magnitudes of driving force.

The first and second actuators may provide same magnitude of driving force.

The lens driving module may also include a crosslink member connecting the first and second actuators to each other.

The lens unit may include a lens.

In accordance with an embodiment, there is provided a lens driving module, including: a plate member; a lens unit disposed on the plate member; and actuators connected to each other, movable relative to each other, and connecting the plate member and the lens unit to each other.

In accordance with another embodiment, there is provided a lens driving module, including: a driving unit configured to move a lens unit and including a first movable frame configured to move relative to a fixed frame, a second movable frame configured to move relative to the first movable frame, a first actuator configured to connect the fixed frame and the first movable frame to each other and provide a driving force to move the first movable frame, and a second actuator configured to connect the first movable frame and the second movable frame to each other and provide a driving force to move the second movable frame.

The lens driving module may also include a third movable frame configured to move relative to the second movable frame; and a third actuator configured to connect the second movable frame and the third movable frame to each other and provide a driving force to move the third movable frame.

The first actuator and the second actuator may be disposed in a tangential direction with respect to the lens unit.

The first movable frame and the second movable frame may be sequentially disposed within an open space of the fixed frame.

The fixed frame may include a protrusion protruding toward the first movable frame, the first movable frame includes a first protrusion protruding toward the fixed frame and a second protrusion protruding toward the second movable frame, and the second movable frame includes a first protrusion protruding toward the first movable frame.

The lens driving module may also include a driving element configured to control the driving force of the first and second actuators.

In accordance with an embodiment, there is provided a lens driving module, including: a first frame member; a second frame member configured to support an edge of a lens unit and including protrusions; a first actuator configured to extend from the first frame member to a crosslink member and moving the lens unit by a first magnitude of a first driving force; and a second actuator configured to extend from the crosslink member to one of the protrusions of the second frame member and moving the lens unit by a second magnitude of a second driving force, different from the first magnitude, wherein the crosslink member extends in a direction perpendicular to the first actuator and the second actuator.

The first actuator may deform in an s-shaped growth curve with a lower end thereof on the first frame member and an upper end thereof on the crosslink member to move the lens unit by a first height.

The second actuator may deform in an s-shaped growth curve with a lower end thereof on the crosslink member and an upper end thereof on the protrusions of the second frame member to push the lens unit by a second height.

The second frame member may be a portion of the lens driving module and is relatively movable in relation to the housing or the lens module of the camera module.

The lens driving module may also include a third actuator, wherein the crosslink member includes a first crosslink member and a second crosslink member, the first actuator extends from the first frame member to the first crosslink member, the second actuator extends from the second crosslink member to the one of the protrusions of the second frame member, and the third actuator extends from the first crosslink member to the second crosslink member.

The first driving force driving the first actuator may be less than the second driving force driving the second actuator and a third driving force driving the third actuator may be greater than the second driving force driving the second actuator.

In accordance with another embodiment, there is provided a lens driving module, including: a first actuator configured to connect to a first crosslink member; a second actuator configured to extend from the first crosslink member to a second crosslink member; and a third actuator configured to connect to a third crosslink member, wherein the first, second, and third crosslink members extend in a direction perpendicular to the first, second, and third actuators, and the first actuator, the second actuator, and the third actuator each are driven by a predefined driving force.

The lens driving module may also include a first frame member; a second frame member configured to support an edge of a lens unit, wherein the first crosslink member is connected to the first frame member, the first actuator extends from the first crosslink member to the second crosslink member, and the third actuator extends from the third crosslink member to the second frame member.

The first, second, and third crosslink members may be parallel to each other.

The predefined driving force driving the first actuator may be equal to the predefined driving force driving the second actuator and the predefined driving force driving the third actuator may be greater than the predefined driving forces driving the first and second actuators.

The lens driving module may also include a first frame member; a second frame member configured to support an edge of a lens unit and including a protrusion, wherein the first actuator extends from the first frame member to the first crosslink member, and the third actuator extends from the second crosslink member to the third crosslink member; and a fourth actuator configured to extend from the third crosslink member to the protrusion of the second frame member.

A configuration of the first, second, and third actuators and the first, second, and third crosslink members may be a zigzag configuration.

The predefined driving force driving the first actuator may be equal to the predefined driving force driving the second actuator and the predefined driving force driving the third actuator may be different from the predefined driving force driving the fourth actuator.

Other features and aspects will be apparent from the following detailed description, the drawings, and the claims.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a plan view of a lens driving module, according to a first embodiment;

FIG. 2 is a cross-sectional view, taken along line I-I′, of the lens driving module shown in FIG. 1, according to an embodiment;

FIG. 3 is a cross-sectional view taken along cross sectional line I-I′ of the lens driving module when a first actuator is driven, according to an embodiment;

FIG. 4 is a cross-sectional view taken along cross sectional line I-I′ of the lens driving module when a second actuator is driven, according to an embodiment;

FIG. 5 is a cross-sectional view taken along cross sectional line I-I′ of the lens driving module when the first actuator and the second actuator are driven, according to an embodiment;

FIG. 6 is a plan view illustrating a lens driving module, according to a second embodiment;

FIG. 7 is a plan view illustrating a lens driving module, according to a third embodiment;

FIG. 8 is a plan view illustrating a lens driving module, according to a fourth embodiment;

FIG. 9 is a plan view illustrating a lens driving module, according to a fifth embodiment;

FIG. 10 is a plan view illustrating a lens driving module, according to a sixth embodiment;

FIG. 11 is a perspective view of a lens driving module, according to another embodiment;

FIG. 12 is an enlarged perspective view of a driving unit shown in FIG. 11, in accordance with an embodiment;

FIG. 13 is an exploded perspective view of a driving unit shown in FIG. 12, in accordance with an embodiment; and

FIG. 14 is an operation state diagram of the driving unit shown in FIG. 11, in accordance with an embodiment.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

It will be understood that when an element or layer is referred to as being “on” or “connected to” another element or layer, it can be directly on or connected to the other element or layer or through intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc. may be used herein to describe various embodiments, elements, components, regions, layers and/or sections, these embodiments, elements, components, regions, layers and/or sections should not be limited by these terms. These terms are only used to distinguish one embodiment, element, component, region, layer or section from another region, layer or section. These terms do not necessarily imply a specific order or arrangement of the embodiments, elements, components, regions, layers and/or sections. Thus, a first embodiment, element, component, region, layer or section discussed below could be termed a second embodiment, element, component, region, layer or section without departing from the teachings description of the present application.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In a miniature camera, a driving distance of a lens unit to perform automatic focus adjustment is short. For example, the driving distance of the lens unit to perform the automatic focus adjustment in the miniature camera is of several hundred micrometers (μm). In order to produce a high-resolution image, the focus may need to be finely adjusted, thus, requiring a greater distance than several hundred micrometers (μm). Once the focus is locked at a certain distance, it stays locked at such distance. If the subject being photographed suddenly moves closer to the camera or further away from the camera, then the subject drops out of focus and appears blurred. However, it is difficult to finely adjust a displacement of approximately several hundred micrometers (μm) using an electrical signal supplied to an actuator driving the lens unit.

In accordance with an illustrative example, the various embodiments to be described, at least, solve the above-mentioned problem, and provide a lens driving module configured to change the driving distance of the lens unit stepwise.

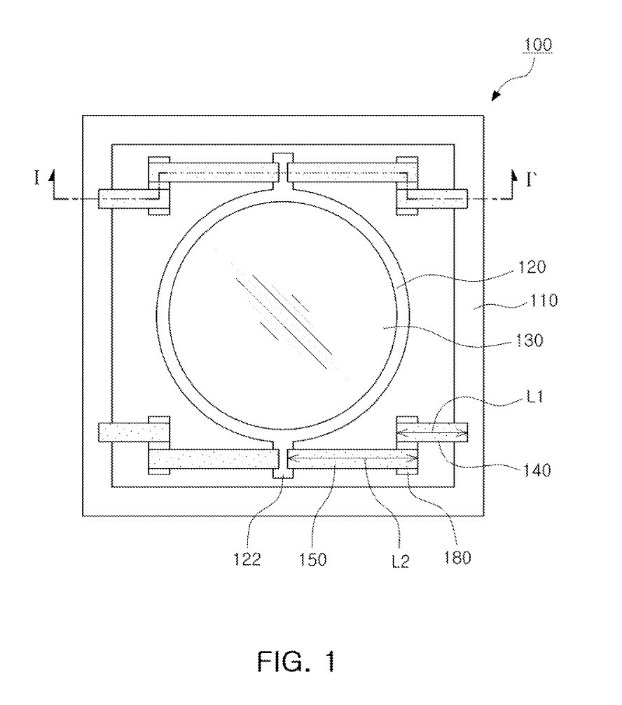

A lens driving module, according to a first embodiment, will be described with reference to FIG. 1.

A lens driving module 100 includes a first frame member 110, a second frame member 120, a lens unit 130, and actuators 140 and 150. Further, the lens driving module 100 includes a crosslink member 180.

The lens driving module 100 is configured as a substantially thin plate shape. For example, the lens driving module 100 is manufactured integrally through an etching process of a wafer. Therefore, a plurality of lens driving modules 100 may be mass-produced through a series of semiconductor manufacturing processes.

The lens driving module 100 is mounted on a camera module. For example, the lens driving module 100 may be mounted on a front (an object side) of the camera module. However, the mounting position of the lens driving module 100 is not limited to the front of the camera module. The lens driving module 100 may be mounted on any portion of the camera module.

The lens driving module 100 performs automatic focus adjustment. For example, the lens driving module 100 performs the automatic focus adjustment by driving lenses forming an optical system of the camera module. Because the lens driving module 100 performs the automatic adjustment by driving only one lens or a few lenses, the amount of current consumed by the lens driving module 100 in the camera module is minimal or reduced. Further, because the lens driving module 100 drives only one lens or few lenses, the lens driving module 100 rapidly drives and precisely performs the automatic focus adjustment.

Next, components of the lens driving module 100 will be sequentially described.

In one configuration, the first frame member 110 is manufactured from a wafer. For example, the first frame member 110 is manufactured in a quadrangular frame form in a wafer machining process. The first frame member 110 is a portion of the lens driving module 100, which is fixed to the camera module. For example, the first frame member 110 is coupled to a housing or a lens barrel of the camera module so as to remain stationary.

Similar to the first frame member 110, the second frame member 120 is manufactured from a wafer. For example, the second frame member 120 is formed integrally with the first frame member 110 in the wafer machining process, and is separated from the first frame member 110 in a secondary machining process. In another example, the second frame member 120 is formed in a separate or independent process from a process forming the first frame member 110. Both processes are, for example, machining process applied to a wafer. Once manufactured, the second frame member 120 is placed within the first frame member 110.

The second frame member 120 is a portion of the lens driving module 100, which is movable in the camera module. For example, the second frame member 120 is relatively movable in relation to the housing or the lens module of the camera module.

The second frame member 120 has a substantial ring shape. For example, the second frame member 120 is manufactured in a circular form so as to support an edge of the lens unit 130. However, the shape of the second frame member 120 is not limited thereto. For example, the second frame member 120 may be of a quadrangular shape or other shapes depending on a shape of a cross-section of the lens unit 130.

The second frame member 120 includes at least two protrusions 122. For example, a pair of protrusions 122, which extend from the second frame member 120 in opposite directions, are formed on the second frame member 120. In one configuration, the pair of protrusions 122 is formed on or extends from an outer circumference of the second frame member 120. In another configuration, the pair of protrusions 122 is formed from an inner circumference of the second frame member 120. In a further configuration, the pair of protrusions 122 is formed over the second frame member 120.

The lens unit 130 is mounted on the second frame member 120. For example, the lens unit 130 is firmly attached to one surface of the second frame member 120. The lens unit 130 includes one or more lenses. The lens unit 130 includes one or more lenses forming the optical system of the camera module. For example, the lens unit 130 includes a first lens disposed on the front (the object side) of the optical system. Further, the lens unit 130 may include a stop. For example, the lens unit 130 includes the first lens and the stop disposed at the front or rear of the first lens.

The lens driving module 100 includes a plurality of actuators. For purposes of brevity, one of the actuators 140 and one of the actuators 150 will be described. However, as shown in FIG. 1, similar structural and functional configurations apply to other actuators in the lens driving module 100. The first actuator 140 is connected to the first frame member 110, and the second actuator 150 is connected to the second frame member 120. In addition, the first actuator 140 and the second actuator 150 are connected to each other through the crosslink member 180.

The first actuator 140 protrudes into the first frame member 110, forming an integral part of the first frame member 110. In another configuration, the first actuator 140 is positioned on the first frame member 110, covering a portion of the first frame member 110. The first actuator 140 is connected to the first frame member 110. For example, four first actuators 140 extend from one side of the first frame member 110 in a substantially tangential direction with respect to the lens unit 130. The first actuator 140 provides a first driving force. For example, the first actuator 140 generates the first driving force from an electrical signal and moves the lens unit 130 by a first magnitude corresponding to the first driving force.

The second actuator 150 is connected to the second frame member 120. For example, four second actuators 150 extend from the protrusions 122 of the second frame member 120 in a substantially tangential direction with respect to the lens unit 130. The second actuator 150 protrudes into one protrusion 122 of the second frame member 120, forming an integral part of the protrusion 122. In another configuration, the second actuator 150 is positioned on one protrusion 122, covering a portion of the protrusion 122. The second actuator 150 provides a second driving force. For example, the second actuator 150 generates the second driving force from an electrical signal and moves the lens unit 130 by a second magnitude corresponding to the second driving force. In one example, the second magnitude from the second driving force of the second actuator 150 is different from the first magnitude of from the first driving force of the first actuator 140.

The crosslink member 180 connects the first actuator 140 and the second actuator 150 to each other. For example, the crosslink member 180 extends in a direction perpendicular to the first actuator 140 and the second actuator 150 so as to be connected to one end of the first actuator 140 and one end of the second actuator 150, respectively. Although FIG. 1 illustrates that the one end of the first actuator 140 is flushed to or aligned with a first vertical side of the crosslink member 180 and the one end of the second actuator 150 is flushed to or aligned with a second vertical side, opposite to the first vertical side, of the crosslink member 180, a person of ordinary skill in the relevant art will appreciate that the one end of the first actuator 140 and the one end of the second actuator 150 may extend pass the first and second vertical sides of the crosslink member 180, respectively.

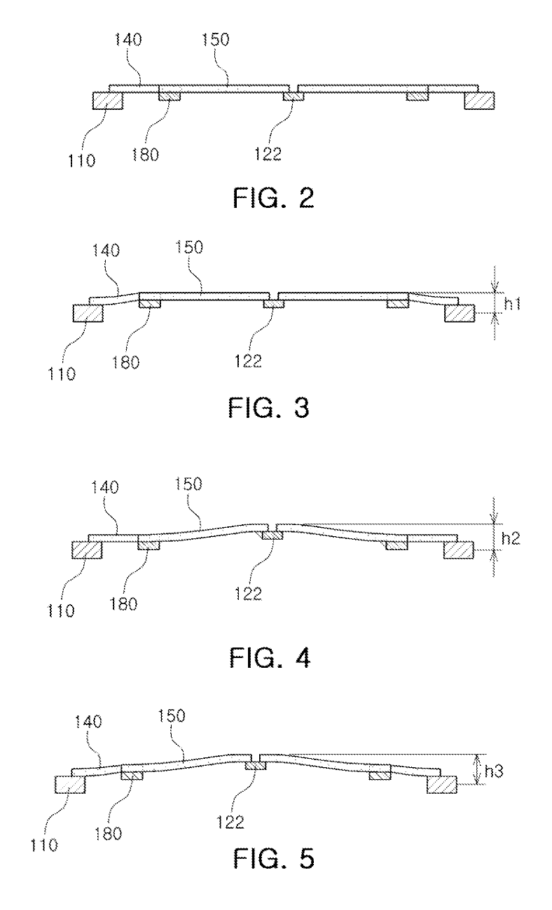

A cross-sectional shape of the lens driving module, taken along cross sectional line I-I′, will be described with reference to FIG. 2.

As shown in FIG. 2, the lens driving module 100 includes the plurality of actuators 140 and 150, which are connected to each other in series. For example, the first actuator 140 extends from the first frame member 110 to the crosslink member 180, and the second actuator 150 extends from the crosslink member 180 to the protrusion 122 of the second frame member 120.

The first and second actuators 140 and 150 generate the driving forces in the same direction to control the lens unit 130 to perform the automatic focus adjustment function. Alternatively, the first and second actuators 140 and 150 generate the driving force in different directions to allow the lens unit 130 to perform a tilt adjustment.

A cross-sectional shape of the lens driving module, taken along cross sectional line I-I′, according to the driving of the first actuator will be described with reference to FIG. 3.

The lens driving module 100 moves the lens unit 130 by a predetermined driving distance. For example, the lens driving module 100 moves the lens unit 130 by a first height h1 by driving the plurality of first actuators 140 in the same direction. In one illustrative example, current flows through the first actuator 140, moving at least one side of the first actuator 140 in a direction away from the first frame member 110, thus, driving the lens unit 130 to move by the first height h1. In one configuration, and as shown in FIG. 3, the current flows through the first actuator 140 so that the first actuator 140 deforms in an s-shaped growth curve with a lower end thereof on the first frame member 110 and an upper end thereof on the crosslink member 180 to move the lens unit 130 by the first height h1.

A cross-sectional shape of the lens driving module, taken along cross sectional line I-I′, according to the driving of the second actuator will be described with reference to FIG. 4.

The lens driving module 100 moves the lens unit 130 by a predetermined driving distance. For example, the lens driving module 100 moves the lens unit 130 by a second height h2 by driving the plurality of second actuators 150 in the same direction. In one illustrative example, current flows through the second actuator 150, moving at least one side of the second actuator 150 in a direction away from the crosslink member 180, thus, driving the lens unit 130 to move by the second height h2. In one configuration, and as shown in FIG. 4, the current flows through the second actuator 150 so that the second actuator 150 deforms in an s-shaped growth curve with a lower end thereof on the crosslink member 180 and an upper end thereof on the protrusions 122 of the second frame member 120 to push the lens unit 130 by the second height h2.

A cross sectional shape of the lens driving module, taken along cross sectional line I-I′, according to the driving of the first actuator and the second actuator will be described with reference to FIG. 5.

The lens driving module 100 moves the lens unit 130 by a predetermined driving distance. For example, the lens driving module 100 moves the lens unit 130 by a third height h3 by driving the plurality of first and second actuators 140 and 150 in the same direction. In one example, the third height h3 may be equal to the sum of the first height h1 and the second height h2, or may be smaller or greater than the sum. In this example, current flows through the first and second actuators 140 and 150, each deforming as described in FIGS. 3 and 4.

For reference, cases in which the automatic focus adjustment function of the lens unit 130 is performed by driving the first and second actuators 140 and 150 in the same direction are illustrated in FIGS. 3 through 5. However, if necessary, a tilt correction of the lens unit 130 is performed by driving the first and second actuators 140 and 150 in different directions.

Hereinafter, modified forms of the lens driving module according to embodiments will be described. For reference, in the following descriptions of the modified forms, the same components as those described above will be denoted by the same reference numerals, and descriptions thereof will be omitted.

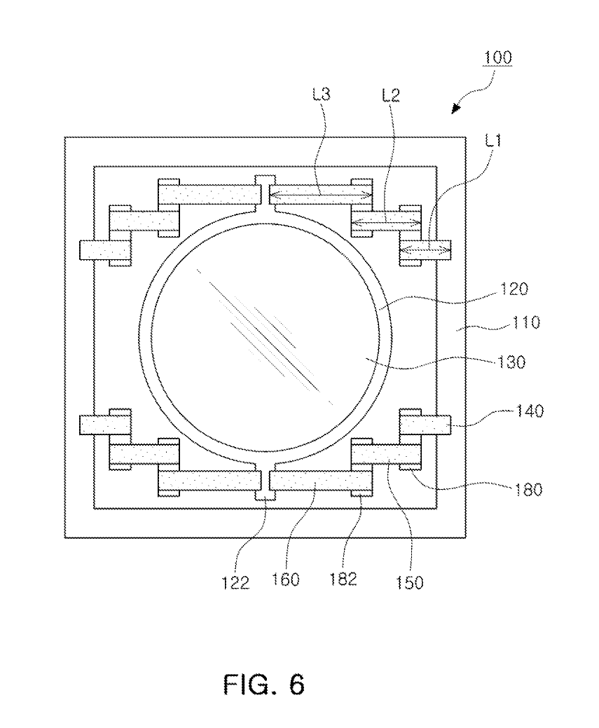

A modified form of the lens driving module according to an embodiment will be described with reference to FIG. 6.

The lens driving module 100, according to an embodiment, is modified from the configuration of FIG. 1 with respect to the number and arrangement of actuators. For example, the lens driving module 100 further includes a third actuator 160. The actuators are configured as the first actuator 140, the second actuator 150, and the third actuator 160 from the first frame member 110 to the second frame member 120. For example, the first actuator 140 extends from the first frame member 110 to the first crosslink member 180, the second actuator 150 extends from the first crosslink member 180 to a second crosslink member 182, and the third actuator 160 extends from the second crosslink member 182 to the protrusion 122 of the second frame member 120.

The first actuator 140, the second actuator 150, and the third actuator 160 may provide different magnitudes of driving force. For example, the first actuator 140 provides a first magnitude of a driving force, the second actuator 150 provides a second magnitude of a driving force, and the third actuator 160 provides a third magnitude of a driving force.

The first actuator 140, the second actuator 150, and the third actuator 160 are, in one embodiment, disposed in the order of magnitudes of corresponding driving forces. For example, the driving force of the first actuator 140 is lower than that of the second actuator 150, and the driving force of the second actuator 150 is lower than that of the third actuator 160. However, the arrangement of the first actuator 140, the second actuator 150, and the third actuator 160 may be changed, if necessary. For instance, the driving forces of the first actuator 140 and the second actuator 150 may be equal and the driving force of the third actuator 160 may be greater than the driving forces of the first and second actuators 140 and 150.

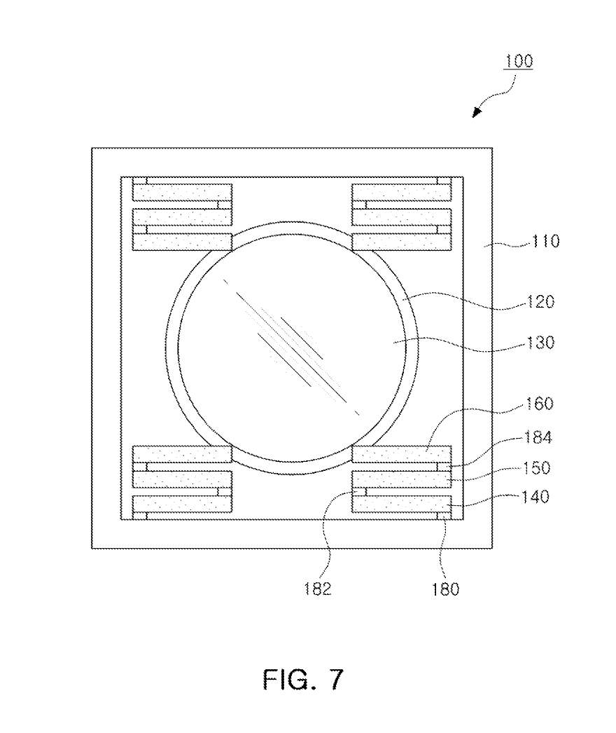

Another modified form of the lens driving module according to an embodiment will be described with reference to FIG. 7.

The lens driving module 100, according to an embodiment, is modified with respect to the arrangement of actuators. For example, the first actuator 140, the second actuator 150, and the third actuator 160 are disposed to be in parallel with each other.

Further, the first actuator 140, the second actuator 150, and the third actuator 160 have the same length. For example, the first actuator 140, the second actuator 150, and the third actuator 160 have the same magnitude of driving force.

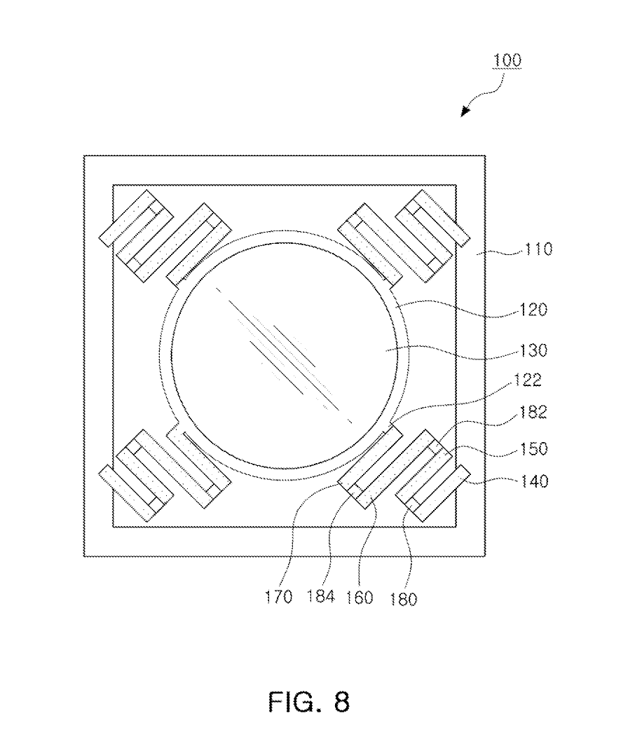

Another modified form of the lens driving module according to an exemplary embodiment will be described with reference to FIG. 8.

The lens driving module 100, according to an embodiment, may be modified with respect to the number and arrangement of actuators. For example, the lens driving module 100 may further include a fourth actuator 170.

A plurality of actuators 140, 150, 160, and 170 are disposed in a zigzag configuration from the first frame member 110 to the second frame member 120. For example, the first actuator 140 extends in a first direction from the first frame member 110 to the first crosslink member 180, the second actuator 150 extends in a second direction from the first crosslink member 180 to the second crosslink member 182, the third actuator 160 extends in the first direction from the second crosslink member 182 to the a third crosslink member 184, and the fourth actuator 170 extends in the second direction from the third crosslink member 184 to the protrusion 122 of the second frame member 120.

At least a portion of the first actuator 140, the second actuator 150, the third actuator 160, and the fourth actuator 170 may provide different magnitudes of driving force. For example, the second actuator 150, the third actuator 160, and the fourth actuator 170 may provide different magnitudes of driving force. Conversely, the first actuator 140 and the second actuator 150 may provide the same magnitude of driving force.

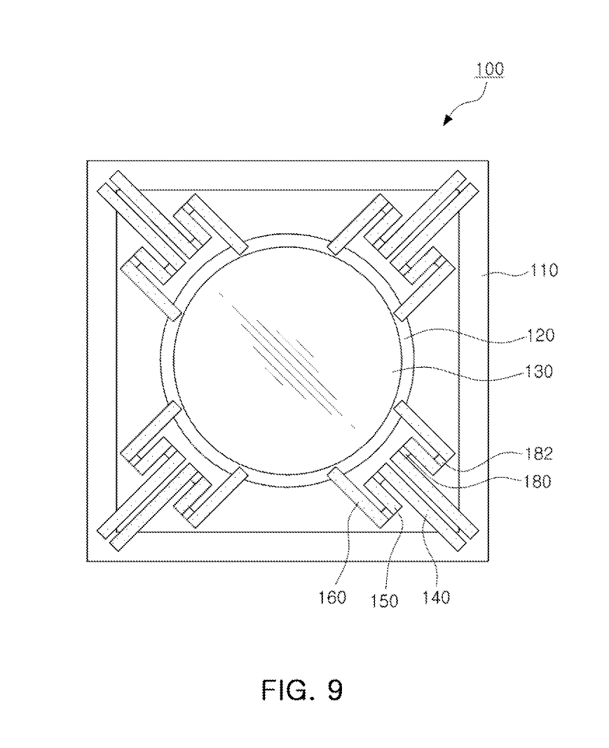

Another modified form of the lens driving module according to an embodiment will be described with reference to FIG. 9.

The lens driving module 100, according to an embodiment, may be modified with respect to the arrangement of actuators. For example, the first actuator 140, the second actuator 150, and the third actuator 160 are disposed to be extended from corners of the first frame member 110 to the center of the lens unit 130.

The first actuator 140, the second actuator 150, and the third actuator 160 are disposed to be in parallel with each other. For example, the first actuator 140 is disposed to be in parallel with the second actuator 150, and the second actuator 150 is disposed to be in parallel with the third actuator 160.

The first actuator 140, the second actuator 150, and the third actuator 160 may have different lengths. For example, the first actuator 140 is longer than the second actuator 150 and the third actuator 160, and the third actuator 160 is longer than the second actuator 150. Therefore, the first actuator 140, the second actuator 150, and the third actuator 160 may provide different magnitudes of driving force.

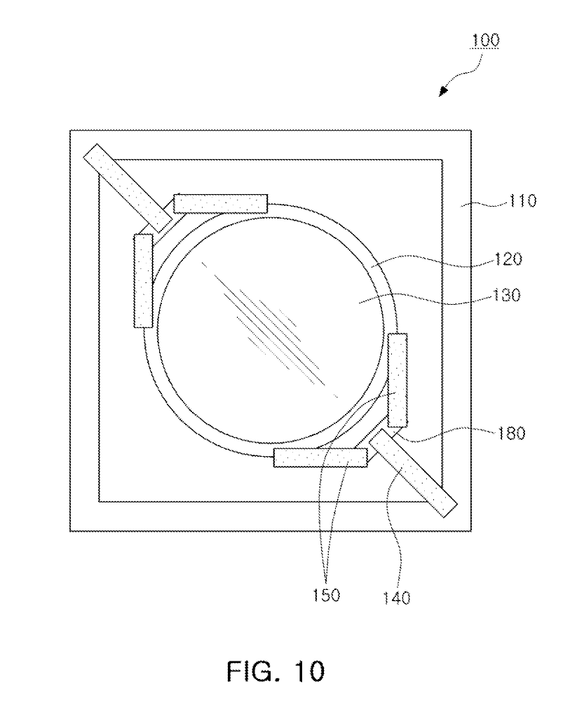

Another modified form of the lens driving module according to an embodiment will be described with reference to FIG. 10.

The lens driving module 100, according to an embodiment, may be modified with respect to the arrangement of actuators. For example, one actuator may be connected to two actuators. For example, the first actuator 140 may be connected to a pair of second actuators 150. That is, the first actuator 140 may be connected to the second actuators 150 by the crosslink member 180.

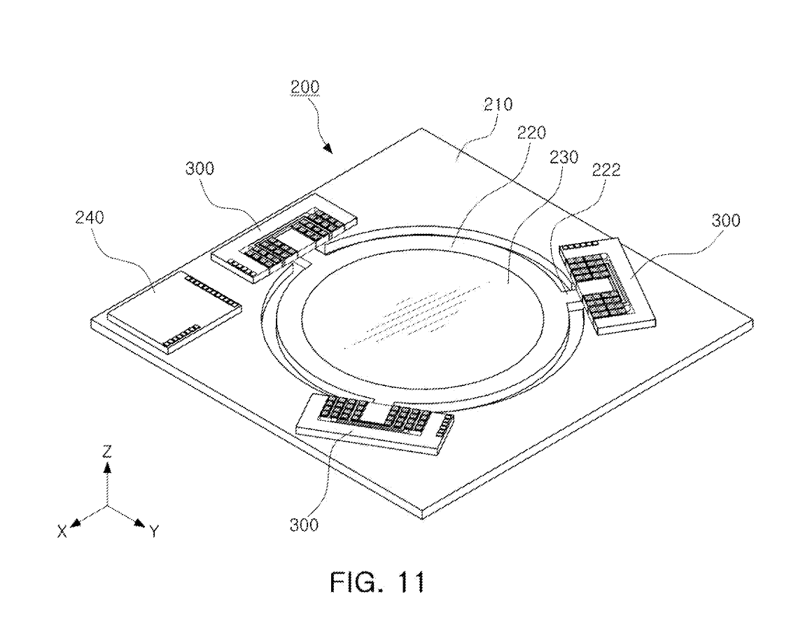

A lens driving module according to another embodiment will be described with reference to FIG. 11.

A lens driving module 200, according to an embodiment, includes a plate member 210, a bearing member 220, a lens unit 230, a driving element 240, and a driving unit 300.

The plate member 210 is manufactured from a substrate. For example, the plate member 210 is manufactured by etching a general circuit substrate. Therefore, the plate member 210 includes one or more circuit patterns. For example, the circuit pattern connects the driving element 240 and the driving unit 300 to each other.

Similar to the plate member 210, the bearing member 220 is manufactured from a substrate. For example, after the bearing member 220 is manufactured integrally with the plate member 210, the bearing member 220 may be separated from the plate member 210 in an additional machining process.

The lens unit 230 is mounted on the bearing member 220. For example, the lens unit 230 is firmly attached on one surface of the bearing member 220. The lens unit 230 includes one or more lenses. For example, the lens unit 230 includes one or more lenses forming the optical system of the camera module. For example, the lens unit 230 includes a first lens disposed on the front (the object side) of the optical system. Further, the lens unit 230 includes a stop. For example, the lens unit 230 includes the first lens and the stop disposed at the front or rear of the first lens.

The driving element 240 is mounted on the plate member 210. For example, the driving element 240 is mounted on a corner portion of the plate member 210, which is a spare area of the plate member 210. The driving element 240 controls the driving unit 300. For example, the driving element 240 is connected to the driving unit 300 by the circuit pattern of the plate member 210 to transmit a control signal to the driving unit 300.

The driving unit 300 moves the lens unit 230 in an optical axis direction or other directions. For example, three driving units 300 is connected to the bearing member 220 supporting the lens unit 230 to move the lens unit 230. For example, the three driving units 300 move the lens unit 230 in the same direction to allow the lens unit 230 to perform the automatic focus adjustment function. As another example, the three driving units 300 move the lens unit 230 in different directions to correct a tilt state of the lens unit 230.

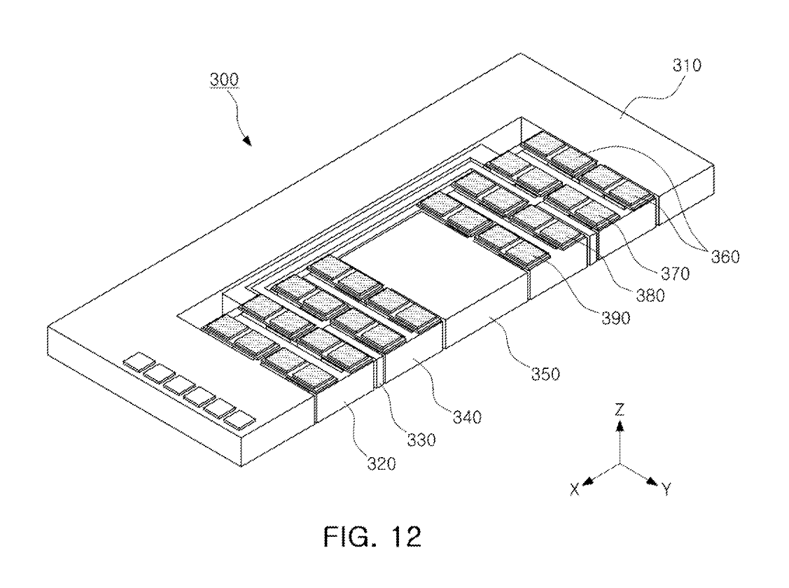

The driving unit will be described with reference to FIG. 12, in accordance with an embodiment.

The driving unit 300 includes a fixed frame 310, movable frames 320, 330, 340, and 350, and actuators 360, 370, 380, and 390.

The fixed frame 310 is mounted on the plate member 210 so as not to remain stationary, and the movable frames 320, 330, 340, and 350 are disposed to be relatively movable in relation to the fixed frame 310. In addition, the actuators 360, 370, 380, and 390 produce a driving force to the movable frames 320, 330, 340, and 350.

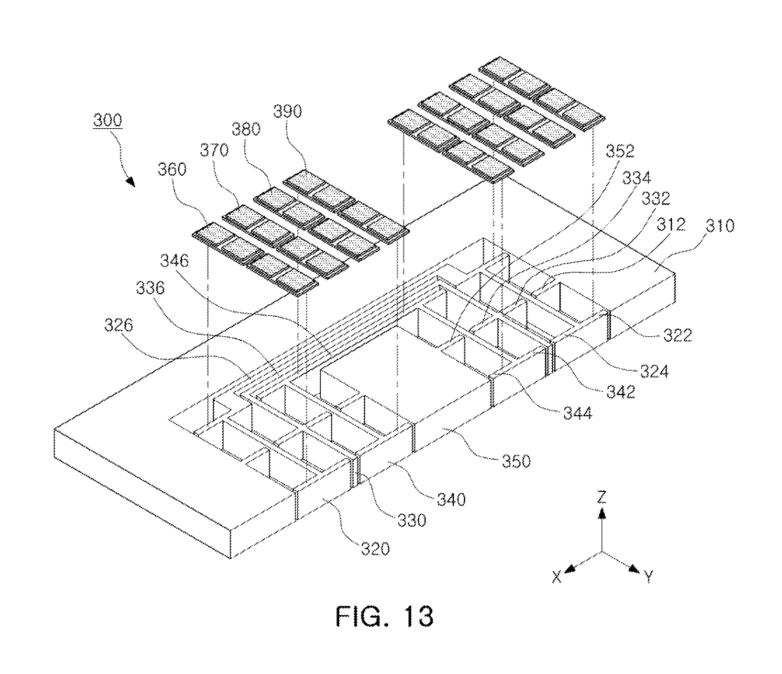

A structure of the driving unit is described with reference to FIG. 13, in accordance with an embodiment.

The fixed frame 310 is formed to have a ‘ [symbol] ’ shape. For example, one side of the fixed frame 310 is open. The fixed frame 310 may be manufactured from a wafer or a substrate. For example, the fixed frame 310 may be manufactured in a wafer machining process.

The fixed frame 310 includes a protrusion 312 for connection with respect to the movable frame 320. For example, a pair of protrusions 312 is extended to the movable frame 320.

The movable frames 320, 330, 340, and 350 are disposed in an open area of the fixed frame 310. For example, a plurality of movable frames 320, 330, 340, and 350 are sequentially disposed in the open space of the fixed frame 310. Similar to the fixed frame 310, the movable frames 320, 330, 340, and 350 may be manufactured from a wafer or the substrate. For example, after the movable frames 320, 330, 340, and 350 are manufactured integrally with the fixed frame 310, the movable frames 320, 330, 340, and 350 are separated from the fixed frame 310 in an additional process.

A plurality of movable frames 320, 330, 340, and 350 are provided. For example, the movable frames 320, 330, 340, and 350 include a first movable frame 320, a second movable frame 330, a third movable frame 340, and a fourth movable frame 350.

The first movable frame 320 is disposed to be closest to the fixed frame 310. For example, the first movable frame 320 is disposed to face an inner peripheral surface of the fixed frame 310. The first movable frame 320 includes a plurality of protrusions 322 and 324. For example, a first protrusion 322 extended to the fixed frame 310 is formed on one side of the first movable frame 320, and a second protrusion 324 extended to the second movable frame 330 is formed on the other side of the first movable frame 320. The first protrusion 322 and the second protrusion 324 are formed at an end of the first movable frame 320.

A pair of first movable frames 320 is disposed to be symmetrical to each other with respect to the center of the driving unit 300. The pair of first movable frames 320 is connected to each other by a connection member 326 so as to be integrally moved.

The second movable frame 330 is disposed to be closest to the first movable frame 320. For example, the second movable frame 330 is disposed to face an inner peripheral surface of the first movable frame 320. The second movable frame 330 includes a plurality of protrusions 332 and 334. For example, a first protrusion 332 that extends to the first movable frame 320 is formed on one side of the second movable frame 330, and a second protrusion 334 that extends to the third movable frame 340 is formed on the other side of the second movable frame 330. The first protrusion 332 is formed so as not to be overlapped with the second protrusion 324 of the first movable frame 320, and the second protrusion 334 is formed so as not to be overlapped with a first protrusion 342 of the third movable frame 340.

A pair of second movable frames 330 is disposed to be symmetrical to each other with respect to the center of the driving unit 300. The pair of second movable frames 330 is connected to each other by a connection member 336 so as to be integrally moved.

The third movable frame 340 is disposed to be closest to the second movable frame 330. For example, the third movable frame 340 is disposed to face an inner peripheral surface of the second movable frame 330. The third movable frame 340 includes a plurality of protrusions 342 and 344. For example, a first protrusion 342 that extends to the second movable frame 330 is formed on one side of the third movable frame 340, and a second protrusion 344 that extends to the fourth movable frame 350 is formed on the other side of the third movable frame 340. The first protrusion 342 and the second protrusion 344 are formed at an end of the third movable frame 340.

A pair of third movable frames 340 is disposed to be symmetrical to each other with respect to the center of the driving unit 300. The pair of third movable frames 340 is connected to each other by a connection member 346 so as to be integrally moved.

The fourth movable frame 350 is disposed to be closest to the third movable frame 340. For example, the fourth movable frame 350 is disposed to face an inner peripheral surface of the third movable frame 340. The fourth movable frame 350 includes a plurality of protrusions 352. For example, the protrusions 352 that extend to the third movable frame 340 are formed on one side and the other side of the fourth movable frame 350. The protrusions 352 are formed so as not to be overlapped with the second protrusion 344 of the third movable frame 340.

The fourth movable frame 350 is connected to a protrusion 222 of the bearing member 220.

The actuators 360, 370, 380, and 390 connect the fixed frame 310 and the movable frames 320, 330, 340, and 350 which are adjacent to each other. For example, the first actuator 360 connects the fixed frame 310 and the first movable frame 320 to each other. More specifically, one end of the first actuator 360 is connected to the protrusion 312 of the fixed frame 310, and the other end thereof is connected to the first protrusion 322 of the first movable frame 320. In a similar manner, the second actuator 370 connects the first movable frame 320 and the second movable frame 330 to each other. For instance, one end of the second actuator 370 is connected to the second protrusion 324 of the first movable frame 320, and the other end thereof is connected to the first protrusion 332 of the second movable frame 330. In a similar manner, the third actuator 380 connects the second movable frame 330 and the third movable frame 340 to each other. For example, one end of the third actuator 380 is connected to the second protrusion 334 of the second movable frame 330, and the other end thereof is connected to the first protrusion 342 of the third movable frame 340. In a similar manner, the fourth actuator 390 connects the third movable frame 340 and the fourth movable frame 350 to each other. More specifically, one end of the fourth actuator 390 is connected to the second protrusion 344 of the third movable frame 340, and the other end thereof is connected to the protrusion 352 of the fourth movable frame 350.

The actuators 360, 370, 380, and 390 disposed as described above enable relative motion of the movable frames 320, 330, 340, and 350. For example, the first actuator 360 enables relative motion of the first movable frame 320 to the fixed frame 310. In a similar manner, the second actuator 370 enables relative motion of the second movable frame 330 to the first movable frame 320. In a similar manner, the third actuator 380 enables relative motion of the third movable frame 340 to the second movable frame 330. In a similar manner, the fourth actuator 390 enables relative motion of the fourth movable frame 350 to the third movable frame 340.

In order to increase the driving distance of the lens unit, the number of movable frames and actuators may be increased. For example, in a case in which one movable frame is added, the fourth movable frame is formed to have a similar shape to the second movable frame, and is disposed to face an inner peripheral surface of the third movable frame. In one illustrative configuration, an added fifth movable frame has a similar shape to that of the movable frame 350 of FIG. 13. The actuators are increased or decreased equally in accordance with the number of movable frames. For example, in a case in which one movable frame is added, one actuator is added. For example, in a case in which three movable frames are added, three actuators re added. The added actuators are disposed to connect the added movable frames and the existing movable frames to each other. A drivable distance and driving stage of the lens unit increase equally in accordance with the number of added movable frames and actuators.

Meanwhile, in order to prevent the size of the module from being excessively increased due to the increase in the number of movable frames and actuators, all or a part of the connection members 326, 336, and 346 are omitted.

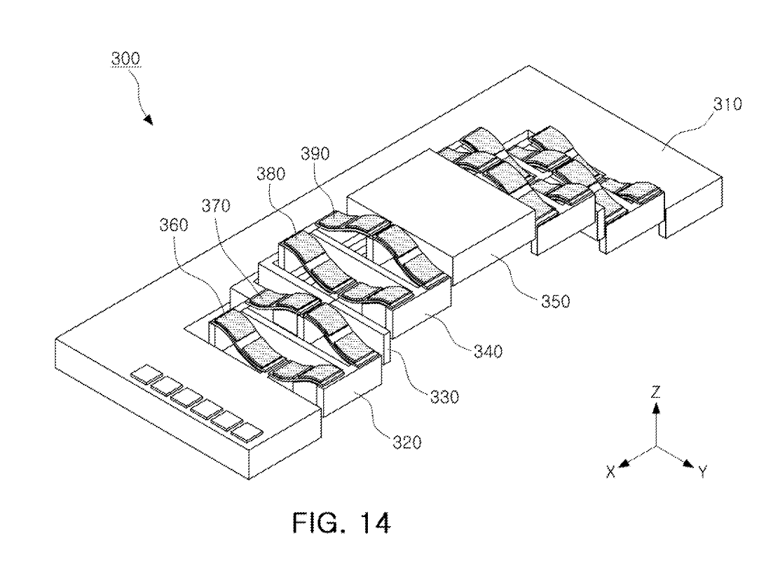

An operation state of the driving unit is described with reference to FIG. 14.

The driving unit 300 finely adjusts the motion of the lens unit 230 by individually or sequentially driving the actuators 360, 370, 380, and 390. For example, the driving unit 300 significantly changes a position of the lens unit 230 by simultaneously driving the actuators 360, 370, 380, and 390, as shown in FIG. 14. As another example, the driving unit 300 may change the position of the lens unit 230 by driving some of the actuators 360, 370, 380, and 390. As another example, the driving unit 300 slightly changes the position of the lens unit 230 by driving only one of the actuators 360, 370, 380, and 390.

Because the driving unit 300 adjusts a displacement of the lens unit in multiple stages, the driving unit 300 performs a fine focus adjustment.

As set forth above, according to various embodiments, the focus may be precisely adjusted.

The units, members, actuators, elements, and modules illustrated in FIGS. 1-14 are implemented by hardware components. Examples of hardware components include processors, lenses, memory, controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens driving module, comprising:
a first actuator configured to move a lens unit; and
a second actuator configured to move the lens unit,
wherein the first and second actuators are connected to be movable relative to each other.

2. The lens driving module of claim 1, further comprising:
a third actuator connected to at least one of the first and second actuators.

3. The lens driving module of claim 1, wherein the first and second actuators are disposed in a direction perpendicular to an optical axis of the lens unit.

4. The lens driving module of claim 1, wherein the first and second actuators are disposed to be symmetrical to each other with respect to the lens unit.

5. The lens driving module of claim 1, wherein the first and second actuators are parallel to each other.

6. The lens driving module of claim 1, wherein the first and second actuators have different lengths.

7. The lens driving module of claim 1, wherein the first and second actuators provide different magnitudes of driving force.

8. The lens driving module of claim 1, wherein the first and second actuators provide same magnitude of driving force.

9. The lens driving module of claim 1, further comprising:
a crosslink member connecting the first and second actuators to each other.

10. The lens driving module of claim 1, wherein the lens unit comprises a lens.

11. A lens driving module, comprising:
a plate member;
a lens unit disposed on the plate member; and
actuators connected to each other, movable relative to each other, and connecting the plate member and the lens unit to each other.

12. A lens driving module, comprising:
a driving unit configured to move a lens unit and comprising
a first movable frame configured to move relative to a fixed frame,
a second movable frame configured to move relative to the first movable frame,
a first actuator configured to connect the fixed frame and the first movable frame to each other and provide a driving force to move the first movable frame, and
a second actuator configured to connect the first movable frame and the second movable frame to each other and provide a driving force to move the second movable frame.

13. The lens driving module of claim 12, further comprising:
a third movable frame configured to move relative to the second movable frame; and
a third actuator configured to connect the second movable frame and the third movable frame to each other and provide a driving force to move the third movable frame.

14. The lens driving module of claim 12, wherein the first actuator and the second actuator are disposed in a tangential direction with respect to the lens unit.

15. The lens driving module of claim 12, wherein the first movable frame and the second movable frame are sequentially disposed within an open space of the fixed frame.

16. The lens driving module of claim 12, wherein the fixed frame comprises a protrusion protruding toward the first movable frame,
the first movable frame comprises a first protrusion protruding toward the fixed frame and a second protrusion protruding toward the second movable frame, and
the second movable frame comprises a first protrusion protruding toward the first movable frame.

17. The lens driving module of claim 12, further comprising:
a driving element configured to control the driving force of the first and second actuators.

18. A lens driving module, comprising:
a first frame member;
a second frame member configured to support an edge of a lens unit and comprising protrusions;
a first actuator configured to extend from the first frame member to a crosslink member and moving the lens unit by a first magnitude of a first driving force; and
a second actuator configured to extend from the crosslink member to one of the protrusions of the second frame member and moving the lens unit by a second magnitude of a second driving force, different from the first magnitude, wherein the crosslink member extends in a direction perpendicular to the first actuator and the second actuator.

19. The lens driving module of claim 18, wherein the first actuator deforms in an s-shaped growth curve with a lower end thereof on the first frame member and an upper end thereof on the crosslink member to move the lens unit by a first height.

20. The lens driving module of claim 18, wherein the second actuator deforms in an s-shaped growth curve with a lower end thereof on the crosslink member and an upper end thereof on the protrusions of the second frame member to push the lens unit by a second height.

21. The lens driving module of claim 18, wherein the second frame member is a portion of the lens driving module and is relatively movable in relation to the housing or the lens module of the camera module.

22. The lens driving module of claim 18, further comprising:
a third actuator, wherein
the crosslink member comprises a first crosslink member and a second crosslink member,
the first actuator extends from the first frame member to the first crosslink member,
the second actuator extends from the second crosslink member to the one of the protrusions of the second frame member, and
the third actuator extends from the first crosslink member to the second crosslink member.

23. The lens driving module of claim 18, wherein the first driving force driving the first actuator is less than the second driving force driving the second actuator and a third driving force driving the third actuator is greater than the second driving force driving the second actuator.

24. A lens driving module, comprising:
a first actuator configured to connect to a first crosslink member;
a second actuator configured to extend from the first crosslink member to a second crosslink member; and
a third actuator configured to connect to a third crosslink member, wherein the first, second, and third crosslink members extend in a direction perpendicular to the first, second, and third actuators, and
the first actuator, the second actuator, and the third actuator each are driven by a predefined driving force.

25. The lens driving module of claim 24, further comprising:
a first frame member;
a second frame member configured to support an edge of a lens unit, wherein
the first crosslink member is connected to the first frame member,
the first actuator extends from the first crosslink member to the second crosslink member, and
the third actuator extends from the third crosslink member to the second frame member.

26. The lens driving module of claim 25, wherein the first, second, and third crosslink members are parallel to each other.

27. The lens driving module of claim 25, wherein the predefined driving force driving the first actuator is equal to the predefined driving force driving the second actuator and the predefined driving force driving the third actuator is greater than the predefined driving forces driving the first and second actuators.

28. The lens driving module of claim 24, further comprising:
a first frame member;
a second frame member configured to support an edge of a lens unit and comprising a protrusion, wherein
the first actuator extends from the first frame member to the first crosslink member, and
the third actuator extends from the second crosslink member to the third crosslink member; and
a fourth actuator configured to extend from the third crosslink member to the protrusion of the second frame member.

29. The lens driving module of claim 28, wherein a configuration of the first, second, and third actuators and the first, second, and third crosslink members is a zigzag configuration.

30. The lens driving module of claim 28, wherein the predefined driving force driving the first actuator is equal to the predefined driving force driving the second actuator and the predefined driving force driving the third actuator is different from the predefined driving force driving the fourth actuator.
